(19) United States
(12) Patent Application Publication
(10) Pub. No.: US 2019/0052027 A1
(43) Pub. Date: Feb. 14, 2019

(54) SUPPORT LIGHTING FOR ELECTRICAL POWER SYSTEMS

(71) Applicant: Darrin Jensen, Dodge Center, MN (US)

(72) Inventor: Darrin Jensen, Dodge Center, MN (US)

(21) Appl. No.: 15/676,490

(22) Filed: Aug. 14, 2017

(51) Int. Cl. H01R 13/717; F21V 23/04; F21V 23/02; F21S 9/02; H01R 13/70

(52) U.S. Cl. CPC H01R 13/7175; F21V 23/04; F21Y 2115/10; F21S 9/02; H01R 13/701; F21V 23/023

(57) ABSTRACT

A lighting system is incorporated into the ends of the electrical power cords to provide light when working in dark environments. The lighting source is preferably battery-operated, thus allowing the user to find power receptacles when in these dark environments. Additionally, a second power source is included in the plug receptacle end, which can be battery-powered or can be powered by electrical power carried within the power lines.

### BACKGROUND

When working at night, or in dark spaces, it is often difficult to locate items or necessary resources. In one particular example, when working in a location with very limited lighting, whether a darkened room or an outdoor location at night, it is typically very difficult to find electrical receptacles when needed. This is especially troublesome when attempting to find need power, which then can be used for lighting and/or necessary tools. In most cases, these situations require the use of a flashlight or some external lighting source. That said, this is often inconvenient since the flashlight may not be nearby or conveniently located. Additionally, this requires the handling of the flashlight, in addition to a cord and other tools that are being carried.

In these cases, it would be particularly beneficial if lighting components were convenient and available when handing the electrical power cords themselves, so that outlets and power sources could be easily located. Clearly, electrical lighting systems do not solve this problem, since the user is searching for a power source in the first place. Obviously, once power is located and sufficiently supplied, electrical spotlights, work lights, etc. can then be utilized.

### SUMMARY

In order to provide a useful tool for locating electrical power sources, a battery-operated lighting source is incorporated into the plug portion of the electrical cord. The battery-operated lighting system is relatively small and self-contained within the plug housing, thus avoiding obstructions with other components and/or other plugs. Further, the battery-operated lighting system is easily operable using a control button located on an outer surface of the plug housing. To provide further utility, this battery operated lighting system is incorporated at the plug-in end of an extension cord, which can then supply power to remote locations. In the extension cord embodiment, the receptacle end may also include a lighting system for use in further illuminating various locations. This lighting system in the receptacle end could be battery operated, or alternatively powered by the electrical power carried within the cord. Again, this receptacle end power lighting system would be easily operated using control buttons located on an outer surface of the receptacle housing.

### BRIEF DESCRIPTION OF THE DRAWINGS

Further objects and advantages of the present invention can be seen from reading the following detailed description, in conjunction with the drawings in which:

FIG. 1 is a perspective view of the lighting system as embodied in an extension cord;

FIG. 2 is a close-up view of the plug-in end of an electrical power cord;

FIG. 3 is a close-up view of the receptacle end of an electrical power cord;

FIGS. 4A and 4B are a top view and an end view, respectively, of the plug-in end;

FIG. 5 is a partial cross-sectional schematic view of the plug-in end of an electrical power cord;

FIGS. 6A and 6B are a top view and end view, respectively, of the receptacle end of an electrical power cord; and

FIG. 7 is a partial cross-sectional schematic view of the receptacle end.

### DESCRIPTION

The disclosed lighting system can be incorporated in multiple electrical systems and/or electrical devices. In one particular embodiment, the incorporation of lighting features into an extension cord is outlined and discussed below. Those skilled in the art will recognize that the same features and advantages can be implemented in multiple devices. The following description is intended to describe the features and advantages of the present invention, and is not intended to be limiting in any way.

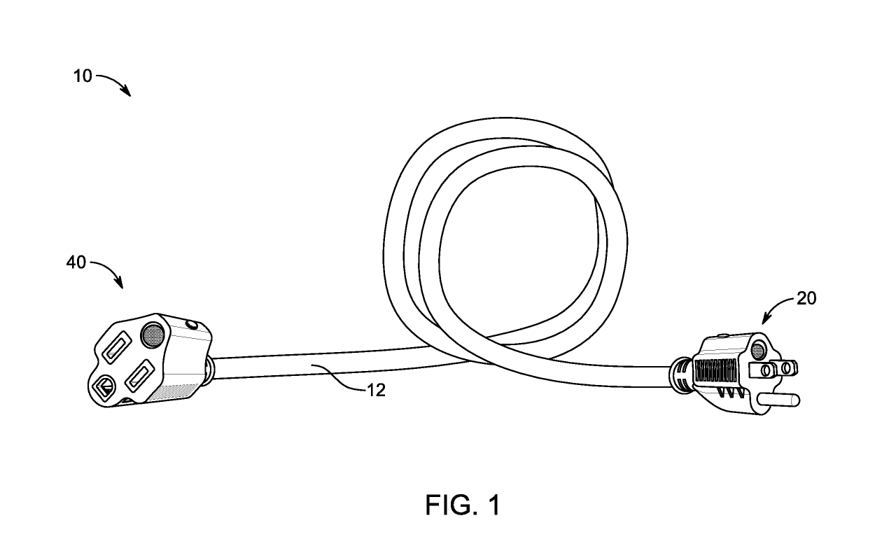

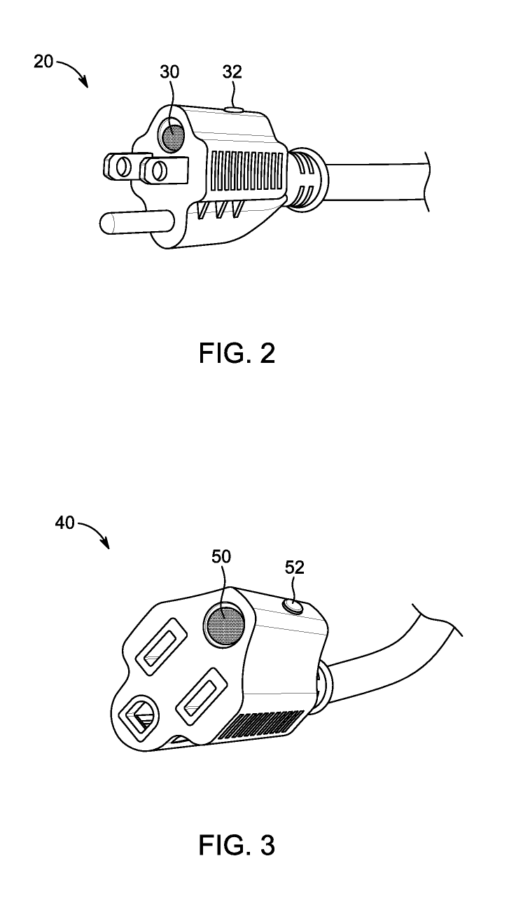

Referring now to FIG. 1, an embodiment of an extension cord 10 is illustrated. As will be recognized, extension cord 10 includes a plug-in end 20, a receptacle end 40 and an electrical cord 12. Plug-in end 20 and receptacle end 40 are both physically and electrically connected to one another via cord 12. Similarly, FIG. 2 shows a close-up view of plug-in end 20 while FIG. 3 illustrates a close-up view of receptacle end 40.

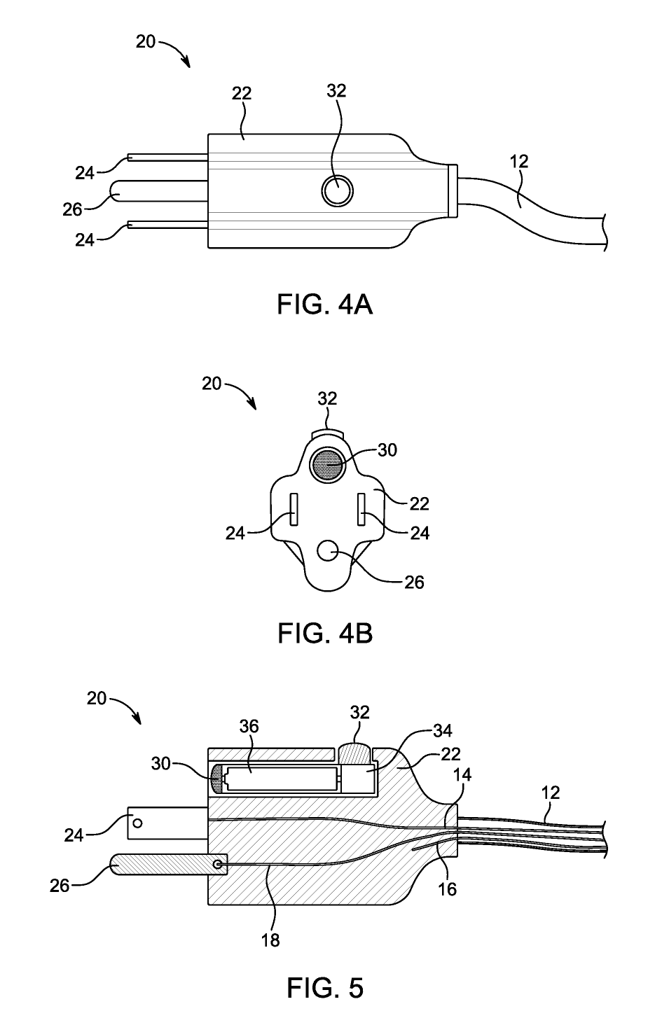

Referring now more specifically to FIGS. 4A and 4B, the plug-in end 20 is illustrated in further detail. More specifically, FIG. 4A shows a top view of plug-in end 20 while FIG. 4B shows a front view thereof. As seen, plug-in end 20 includes a housing 22 with electrical prongs 24 and a ground prong 26 extending from one end thereof. As will be recognized, this is the classical American three-prong electrical plug. Those skilled in the art will recognize that the configuration of plugs can vary, depending upon the specific need and international requirement involved. As also illustrated, a lighting system switch 32 is located on an upper side of housing 22. Further, a lightbulb 30 is positioned within housing 22, and is aimed or directed generally in the same direction as prongs 24 and 26. As will be further discussed below in relation to FIG. 5, lightbulb 30 is part of a battery-operated lighting system contained within housing 22, and which is operable using button 32.

To further illustrate the internal workings of plug-in end 20, FIG. 5 illustrates a schematic cross-sectional view of this component. As previously mentioned, housing 22 contains lightbulb 30, and accommodates switch 32. Housing 22 will also include appropriate electrical connections or wires 14, 16, 18, to provide electrical power down cord 12. As recognized, these electrical connections are coupled to prongs 24 and ground prong 26. Also illustrated in FIG. 5 is switch 32, which is coupled to an electrical switching mechanism 34, and which will provide controlled connections so that power to and from a battery 36 is provided to lightbulb 30. While multiple switching mechanisms are possible, this approach provides a relatively straightforward connection which is also unobtrusive and convenient for a user.

As will be recognized, the plug-in end 20 illustrated in FIGS. 4 and 5 will easily allow a battery-operated light to be controlled by a user. Again, this could be incorporated into an extension cord as outlined above, or could be included in any appliance cord. This additional utility will allow any user to locate electrical receptacles when operating in dark environments or circumstances.

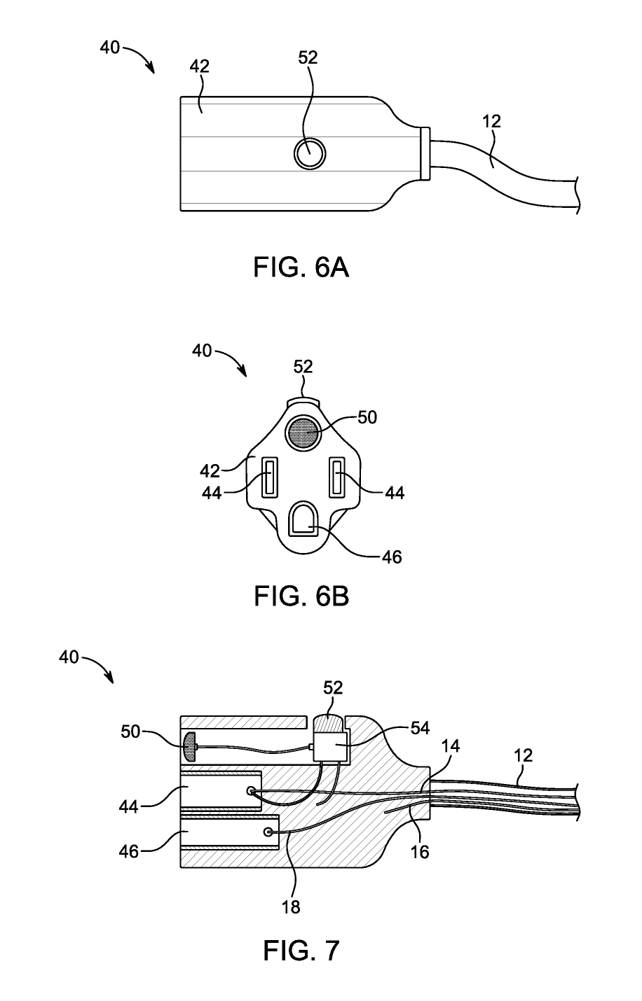

As generally discussed above, one embodiment of the present invention further includes a light source incorporated into the receptacle end 40 of an extension cord 10. Referring now to FIGS. 6A and 6B, the receptacle end 40 is better illustrated. Further, FIG. 7 illustrates a partial cross-sectional view, illustrating the internal components of receptacle end 40, as contemplated.

Referring now to FIGS. 6A and 6B, receptacle end 40 similarly includes a housing 42 which is designed to contain the components needed to provide electrical connections. Specifically, this will generally include a pair of power receptacles 44, and a ground receptacle 46. Contained within a front side of receptacle end 40 is a light source 50, which is operated by a push button switch 52 located on a top side of housing 42. Referring now specifically to FIG. 7, a cross-sectional schematic view is illustrated, which helps illustrate the inner workings of receptacle end 40. In this particular embodiment, bulb 50 is electrically connected to a switching mechanism 54. Switching mechanism 54 is operably connected to push button 52 to accommodate convenient user operation. As will be anticipated, ground receptacle 46 is similarly connected to an electrical cable 18. Power receptacle 44 is similarly connected to one of the required power cords 14 in order to provide necessary operation. Although not specifically illustrated in FIG. 7, a second electrical cord 16 will be operably connected to the other power receptacle 44. In receptacle end, electrical power is provided to switch 54 via internal electrical connections to the power supply lines. In this way, electrical power for light 50 is obtained only when the plug-in end 20 is connected to an electrical power source. This provides yet a further utility for the present invention, as the user is able to illuminate a work area or surroundings after electrical connections are obtained.

Various embodiments of the invention have been described above for purposes of illustrating the details thereof and to enable one of ordinary skill in the art to make and use the invention. The details and features of the disclosed embodiment[s] are not intended to be limiting, as many variations and modifications will be readily apparent to those of skill in the art. Accordingly, the scope of the present disclosure is intended to be interpreted broadly and to include all variations and modifications coming within the scope and spirit of the appended claims and their legal equivalents.

1. An electrical system having support lighting incorporated into an electrical cord to assist in use, comprising:
an electrical cord having a plug-in end and a receptacle end;
a first housing coupled to the plug-in end of the electrical cord and supporting a plug-in capability of the electrical system;
a second housing coupled to the electrical cord opposite at the plug-in end, the second housing supporting a receptacle capability of the electrical system, wherein the plug-in end and the receptacle end are electrically connected to one another;
a light system incorporated into the first housing, the light system having a light bulb, a battery configured to power the bulb, and a switch for selectively powering the light bulb, wherein the switch is located on an outer side of the housing and the light bulb is positioned to direct light out of the first housing; and
wherein the second housing supports a second lighting system which comprises a second lighting system having a switch capable of selectively operating a second light bulb to direct light out of the second housing.

2. The electrical system of claim 1 wherein the first housing has prongs extending from a first side of thereof, and wherein the light bulb is positioned within the first housing so the light bulb is directed to illuminate in the direction of the extended prongs and away from the first housing.

3. The electrical system of claim 2 wherein the switch is located on an upper surface of the housing so the light system can be easily operated while a user is attempting to insert the prongs into a related receptacle.

4. The electrical system of claim 1 wherein the light bulb is an LED bulb.

5. The electrical system of claim 1 wherein the battery is rechargeable.

6. The electrical system of claim 1 wherein the second housing comprises a receptacle which is configured to receive prongs.

7. (canceled)

8. The electrical system of claim 1 wherein the second lighting system is further selectively connected to the electrical cord such that the bulb can be operated by electrical current being carried by the cord.

9. An electrical system having support lighting allowing a user to illuminate a desired area where the cord is to be used, comprising:
an electrical cord having conductor wires configured to carry electrical current;
a first housing coupled to a first end of the electrical cord, the first housing supporting a set of electrical prongs configured to be coupled to an electrical receptacle, wherein the electrical prongs are electrically coupled to the conductor wires within the electrical cord, the first housing further supporting a light system comprising a bulb, a battery power source and a switch for selectively powering the bulb, wherein the bulb is aligned to produce a beam of light directed outwardly from the first housing in a direction substantially parallel with and in line with a direction of the prongs thus allowing a user to illuminate the desired area of use;
a second housing coupled to a second end of the electrical cord, the second housing supporting a receptacle structure configure to receive electrical prongs, the receptacle structure electrically coupled to the connector wires such that an electrical connection exists between the receptacle structure and the electrical prongs, the second housing further supporting a second lighting system having a bulb, a switch and a power connection, the power connection supplying power from the electrical cord to the switch so power from the cord can be selectively supplied to the bulb of the second lighting system, wherein the bulb of the second lighting system is aligned to produce beam of light directed outwardly from the second housing in a direction substantially in line with a direction of the receptacle structure.

10. The electrical system of claim 9 wherein the power source of the first lighting system is a battery.

11. The electrical system of claim 10 wherein the switch of the first lighting system is positioned on an upper surface of the housing so the light system can be easily operated while a user is attempting to insert the prongs into a related electrical outlet.

12. The electrical system of claim 11 wherein the switch of the second lighting system is positioned on an upper surface of the housing so the second light system can be easily operated while a user is holding the second housing.

13. The electrical system of claim 9 wherein the second housing also supports a second battery system so the second lighting system can be operated using power from the battery or power from the cord.

14. The electrical system of claim 9 wherein the prongs comprise three prongs including a positive, negative and ground prong.

15. The electrical system of claim 10 wherein the battery is rechargeable.

16. The electrical system of claim 10 wherein the second housing further comprises an internal lighting system configured to internally illuminate the second housing when the first housing is connected to an electrical power source.

17. The electrical system of claim 16 wherein the first housing supports a lens which is positioned in front of the bulb to provide a controlled beam of light to be emitted from the first housing when the bulb is illuminated, and wherein the second housing supports a second lens positioned in front of the second bulb to provide a controlled beam of light when second bulb is illuminated.
